(19) United States
(12) Patent Application Publication
(10) Pub. No.: US 2010/0073821 A1
(43) Pub. Date: Mar. 25, 2010

(54) MAGNETIC DISK APPARATUS

(75) Inventor: Kiyoto Matsui, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/502,266

(22) Filed: Jul. 14, 2009

(30) Foreign Application Priority Data
Sep. 25, 2008 (JP) 2008-245590

(51) Int. Cl. G11B 5/60

(52) U.S. Cl. 360/235.4; G9B/5.229

(57) ABSTRACT

A magnetic disk apparatus includes a magnetic disk, a spindle motor for rotation of the magnetic disk, and a slider formed with a magnetic head for information reading or writing with respect to the magnetic disk. The slider is arranged to float above the surface of the magnetic disk when the disk is rotating. The magnetic disk apparatus also includes a swing arm for supporting and moving the slider above the magnetic disk, and a ramp disposed adjacent to the outer circumference of the magnetic disk for holding the slider at a withdrawal position which is spaced away from the surface of the magnetic disk. For an information leakage prevention, a hitting mechanism is provided, which is arranged to hit the slider held at the withdrawal position.

### CROSS-REFERENCE TO RELATED APPLICATION

This application is based upon and claims the benefit of priority of the prior Japanese Patent Application No. 2008-245590, filed on Sep. 25, 2008, the entire contents of which are incorporated herein by reference.

### FIELD

An embodiment of the present invention relates to a magnetic disk apparatus provided with an information leakage prevention.

### BACKGROUND

A magnetic disk apparatus provided with an information leakage prevention is described in Japanese Laid-open Patent Publication No. 2007-207100. This magnetic disk apparatus is capable of establishing radio communication with a mobile telephone terminal, and destroying its built-in magnetic disks upon receiving a destruction command signal transmitted from the mobile telephone terminal.

Specifically, the magnetic disk apparatus, upon receiving a destruction command signal, causes the magnetic disk to rotate at a very low speed, with the swing swung over the disk. Due to the slow disk rotation, however, little air flow is generated between the magnetic disk and the slider. Thus, failing to float above the magnetic disk, the slider is held in contact with the surface of the disk being rotated. As the slider is moved in contact with the magnetic disk, the surface of the magnetic disk is scratched, thereby rendering it impossible to retrieve the recorded information. As another example of information leakage prevention, a destruction arm may be provided in addition to a swing arm for the magnetic head. The destruction arm is provided at its tip with a damaging needle. As the destruction arm is swung in response to a destruction command signal, the surface of the magnetic disk is scratched by the damaging needle.

However, in the above-described magnetic disk apparatuses, the disk destroying system is rather complicated, and the need for the radio communications feature adds to the cost of the whole system.

By a more primitive method, the magnetic disk apparatus may be dismantled to take the magnetic disk out and then destroy it. Unfavorably, such a method is often time-consuming and troublesome since the housing case of a magnetic disk apparatus is typically assembled with a number of hexalobular screws that require a special screwdriver to be loosened.

### SUMMARY

Embodiments of the present invention have been proposed under the above-described circumstances. It is therefore an object of an embodiment of the present invention to provide a magnetic disk apparatus equipped with a simple and inexpensive magnetic disk destruction mechanism.

According to an embodiment of the present invention, a magnetic disk apparatus is provided, which includes: a magnetic disk; a spindle motor for rotation of the magnetic disk; a slider formed with a magnetic head for information reading or writing with respect to the magnetic disk, the slider floating above a surface of the magnetic disk in rotation; a swing arm for supporting and moving the slider above the surface of the magnetic disk; a ramp disposed adjacent to an outer circumference of the magnetic disk for holding the slider at a withdrawal position spaced away from the surface of the magnetic disk; and a hitting mechanism for hitting the slider at the withdrawal position.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a plan view illustrating the inner structure of a magnetic disk apparatus according to an embodiment of the present invention;

FIG. 2 is a sectional view illustrating a primary portion of the magnetic disk apparatus of FIG. 1;

FIG. 3 is a sectional view illustrating the primary portion of the magnetic disk apparatus of FIG. 1;

FIG. 4 is a sectional view illustrating the primary portion of the magnetic disk apparatus of FIG. 1; and

FIG. 5 is a sectional view illustrating a primary portion of a magnetic disk apparatus according to another embodiment of the present invention.

### DESCRIPTION OF EMBODIMENTS

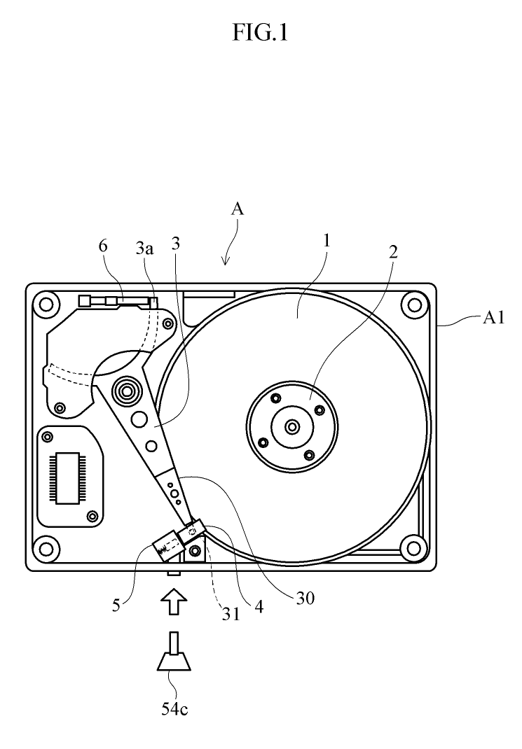

FIGS. 1 through 4 illustrate a magnetic disk apparatus according to an embodiment of the present invention. As depicted in FIG. 1, the magnetic disk apparatus A includes a magnetic disk 1, a spindle motor 2, a swing arm 3, a ramp 4 and a hitting mechanism 5.

The magnetic disk 1 is a storage medium to which information is written and from which the stored information is retrieved. When the power to the magnetic disk apparatus A is turned on, the spindle motor 2 begins to turn the magnetic disk 1 and may keep it rotating at a predetermined high speed, e.g. 6000 rpm.

When the power is turned off, on the other hand, the spindle motor 2 brings the rotating magnetic disk 1 to a halt. The spindle motor 2 also stops the rotation of the magnetic disk 1 in a stand-by mode (when the power is on).

The swing arm 3 has a tip to which a suspension 30 is connected, and a slider 31 is attached to an end of the suspension 30. Thus, the slider 31 is supported by the swing arm 3 via the suspension 30. The slider 31 is formed with a magnetic head. The swing arm 3 makes a swinging movement to move the magnetic head in a reciprocating path above the surface of the magnetic disk 1 radially of the disk. The swing arm 3 is driven by a voice-coil motor.

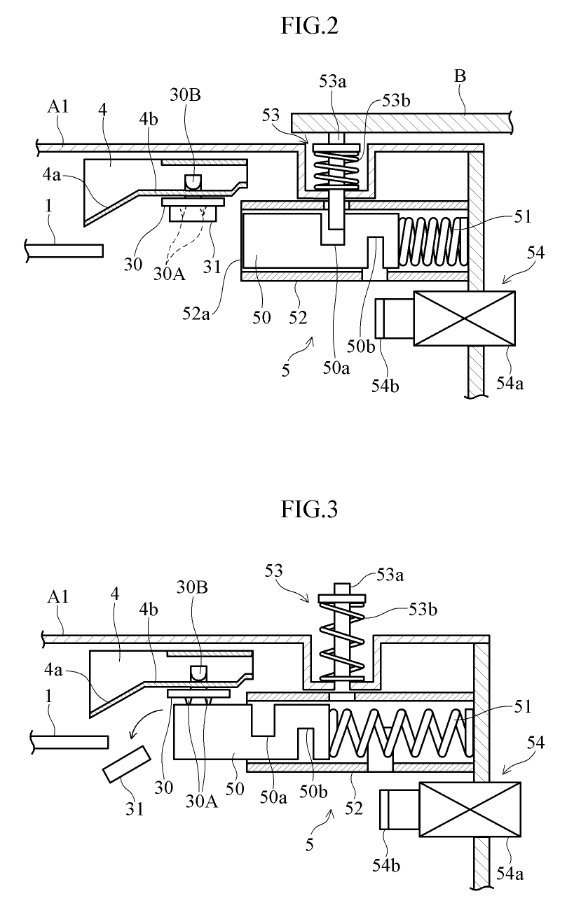

The suspension 30 may be a leaf spring that supports the slider 31 elastically in the thickness direction of the magnetic disk 1. As depicted in FIG. 2, the suspension 30 has projections 30A which are provided on a base-end side of the slider 31, each projecting toward the surface of the magnetic disk 1. When the slider 31 is attached to the suspension 30, the projections 30A have a greater distance to the magnetic disk 1 than the slider 31 does (in other words, the pointed end of each projection 30A does not protrude downward beyond the lower surface of the slider 31). Accordingly, the projections 30A make no contact with the surface of the magnetic disk 1 even when the slider 31 is located immediately above the disk 1. On the other hand, when the slider 31 is detached from the suspension 30 (see FIG. 3), the projections 30A can come into contact with the surface of the magnetic disk 1.

In the normal state of use, the slider 31 floats above the surface of the magnetic disk 1 in rotation, with a slight air gap produced by a stream of air flowing along the surface of the magnetic disk. The magnetic head is formed on an end face of the slider 31, and through the magnetic head, information reading and writing are performed with respect to the magnetic disk 1.

The ramp 4 is provided near the outer circumference of the magnetic disk 1 for holding the slider 31 evacuated from above the surface of the magnetic disk 1 when the magnetic disk 1 stops rotating. As depicted in FIG. 2, when the rotation of the magnetic disk 1 stops, the swing arm 3 is moved away from the rotational center of the disk 1 to a position above the outer circumference of the magnetic disk 1 (see also FIG. 1). In this movement, a tab 30B, formed on the suspension 30, comes into sliding engagement with an inclined surface 4a of the ramp 4. As the swing arm 3 is moved further outward of the disk 1, the tab 30B slides up the inclined surface 4a of the ramp 4 to reach a holding surface 4b. On the holding surface 4b, the slider 31 is held in a withdrawn state outside the magnetic disk 1. As depicted in FIG. 1, under the state where the slider 31 is withdrawn on the ramp 4, the base end 3a of the swing arm 3 is restrained in its movement by a locking mechanism 6. Thus, even if there is an impact applied to the magnetic disk apparatus A from outside, the swing arm 3 does not swing toward the magnetic disk 1, and the slider 31 remains to be in the withdrawn state on the ramp 4. When the electric power is applied for the reading or writing of information, the locking mechanism 6 releases the base end 3a of the swing arm 3, allowing the swing arm 3 to move toward the magnetic disk 1.

The hitting mechanism 5 is configured to strike the slider 31 in the withdrawn state on the ramp 4. As depicted in FIG. 2, the hitting mechanism 5 includes a hitting member 50, a shooting spring 51, a cylinder 52, an automatic stopper mechanism 53, and a user-operable stopper mechanism 54. The hitting member 50 is shot to the slider 31 by the elastic urging force of the spring 51. The cylinder 52 houses the hitting member 50 and the spring 51. The automatic stopper mechanism 53 holds the hitting member 50 in place during normal use, but releases the hitting member 50 when the magnetic disk apparatus is removed from the installation site such as a drive bay. The other stopper mechanism 54 is operable by the user and can selectively be brought into or out of engagement with the hitting member 50.

The hitting member 50 has recessed sections 50a and 50b for engagement with the stopper mechanisms 53 and 54, respectively. In normal state of use, the hitting member 50 is housed in the cylinder 52 and is being urged toward the slider 31 by the elastic force of the spring 51. At the same time, the hitting member 50 is restrained by the engagement with the stopper mechanism 53 at the engagement section 50a. In this state, the hitting member 50 is not restrained by the user-operable stopper mechanism 54. Thus, when the engagement with the stopper mechanism 53 is broken, the elastic force of the spring 51 will shoot the hitting member 50 from the cylinder 52 to hit the slider 31 strongly. Under a different situation, the hitting member 50 is out of engagement with the automatic stopper mechanism 53, but in engagement with the user-operable stopper mechanism 54 so that the hitting member 50 stays in the cylinder 52.

In the cylinder 52, the spring 51 is compressed by the hitting member 50. When the hitting member 50 is released from the engagement, the spring 51 recovers its initial shape and its elastic force pushes the hitting member 50 outward.

The cylinder 52 has an opening 52a for allowing the hitting member 50 to be shot toward the slider 31. The cylinder 52 also has appropriate holes for allowing the two stopper mechanisms 53, 54 to come into engagement with the inside hitting member 50.

The automatic stopper mechanism 53 includes a pin 53a and a spring 53b. The pin 53a is inserted through a hole formed in a housing case A1 of the magnetic disk apparatus A and engages with the engagement section 50a of the hitting member 50. The spring 53b elastically urges the pin 53a away from the housing case A1. When the magnetic disk apparatus A is properly mounted, for example, in a drive bay of a personal computer's main body, or inside a portable terminal device, the pin 53a makes contact with a predetermined portion B of the section at which the disk apparatus is installed, thereby deflecting the spring 53b into a compressed state. In this situation, the pin 53a is in engagement with the engagement section 50a of the hitting member 50. Then, when the magnetic disk apparatus A is removed from the installation site, the pin 53a becomes free from the engagement with the portion B, to be pulled out of the engagement section 50a of the hitting member 50 by the spring 53b.

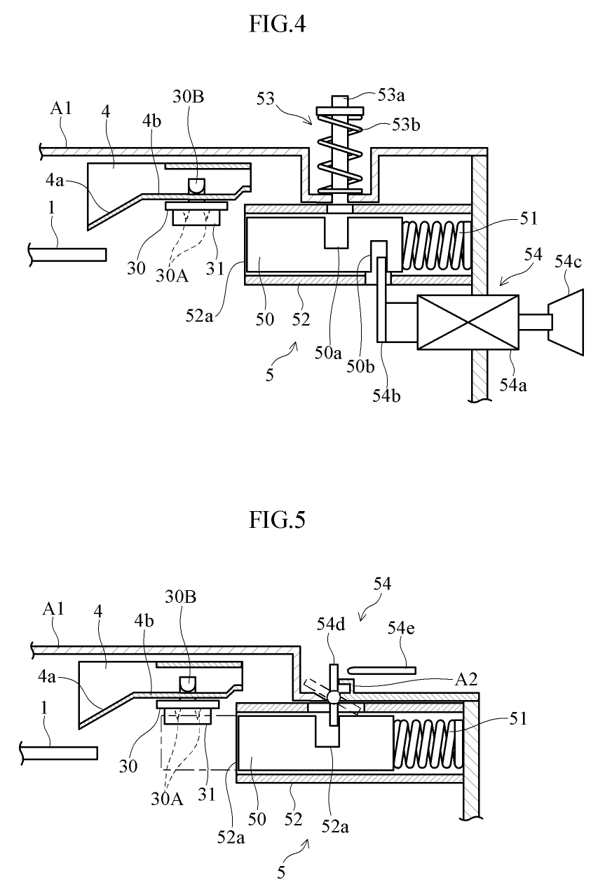

The user-operable stopper mechanism 54 includes a key cylinder 54a, an engagement member 54b, and a key 54c to be inserted into the key cylinder 54a (see FIG. 4). The key cylinder 54a extends through a wall of the housing case A1. The engagement member 54b can come into engagement with the engagement section 50b of the hitting member 50 by the rotation of the key cylinder 54a. In order to remove the magnetic disk apparatus A from the installation site, the user inserts the key 54c into the key cylinder 54a, and turns the key to bring the engagement member 54b into engagement with the engagement section 50b of the hitting member 50. In this manner, the hitting member 50 is not shot to the slider 31 when the automatic stopper mechanism 53 is disengaged.

The workings of the magnetic disk apparatus A will be described below.

FIG. 2 illustrates the normal state of use in which the magnetic disk apparatus A is installed at a predetermined site. In this state, the hitting member 50 is engaged by the automatic stopper mechanism 53 (but not by the user-operable stopper mechanism 54) to be unmoved inside the cylinder 52. Thus, no physical damage is caused as the swing arm 30 is moved for reading or writing information while the magnetic disk 1 is rotating, or as the slider 31 is being withdrawn onto the ramp 4 when the rotating of the magnetic disk 1 is stopped.

FIG. 3 illustrates a situation in which someone unauthorized has removed the magnetic disk apparatus A from the installation site. In this case, the automatic stopper mechanism 53 disengages from the hitting member 50, thereby allowing the hitting member 50 to be shot from the cylinder 52 to hit the slider 31. Upon being hit, the slider 31 may fall off the suspension 30, or at least be deformed if it stays on the suspension 30.

With the slider 31 fallen, the magnetic disk apparatus A may be connected with a personal computer, and the electric power is turned on in an attempt to read information from the magnetic disk 1 of the apparatus A. As the magnetic disk 1 turns, the swing arm 3 starts moving for a seeking operation. In the absence of the slider 31, however, the projections 30A on the suspension 30 come into contact with the rotating magnetic disk 1. Accordingly, the surface of the magnetic disk 1 is physically damaged, i.e. scratched, by the projections 30A, so it becomes impossible to read the stored information from the disk 1. In another case where the slider 31 has not fallen off but has been physically damaged, the deformed slider 31 fails to produce an appropriate stream of air, so that the slider 31 (or part of the suspension 30) is held in contact with the rotating magnetic disk 1. Thus, the surface of the magnetic disk 1 is physically damaged, thereby making it impossible to retrieve the stored information from the disk 1.

FIG. 4 illustrates a situation where the well-informed user on the information leakage prevention is to remove the magnetic disk apparatus A in order to use it with e.g. a different personal computer. In this case, the user inserts the key 54c into the key cylinder 54a and turns the key, thereby immobilizing the hitting member 50 with the user-operable stopper mechanism 54. Thereafter, when the magnetic disk apparatus A is removed from the installation site, the automatic stopper mechanism 53 disengages, but the user-operable stopper mechanism 54 remains to be in engagement with the hitting member 50. Thus, the hitting member 50 is not shot from the cylinder 52. Accordingly, the user can remove the magnetic disk apparatus A without causing any physical damage to the apparatus A.

The magnetic disk apparatus A described above is advantageous in that the mechanism for damaging the magnetic disk 1 is achieved by adopting a simple and inexpensive set of components for a hitting mechanism 5. Supposing that the magnetic disk apparatus A is stolen, the thief will turn on the power, not knowing that the slider 31 has been out of order. Consequently, the surface of the magnetic disk 1 will be scratched before the stored information is retrieved. In this manner, information leakage from the magnetic disk 1 can be prevented with simple but reliable measures.

FIG. 5 illustrates a magnetic disk apparatus according to another embodiment of the present invention. In this figure, the elements which are identical or similar to those described in the previous embodiment will be indicated by the same reference symbols.

In the arrangements depicted in FIG. 5, use is made of no automatic stopper mechanism but only a use-operable stopper mechanism 54. The illustrated stopper mechanism 54 includes a rotation member 54d which is supported rotatably at it center and attached to an appropriate portion of the housing case A1. The stopper mechanism 54 also includes a pin 54e for pushing and thereby turning the rotation member 54d counterclockwise (as viewed in FIG. 5) about an axis. In the normal state of operation, the rotation member 54d is held in engagement with the engagement section 50a of the hitting member 50 (which is urged to the left by the spring 51). As seen from FIG. 5, the upper portion of the rotation member 54d is held in engagement with a stopper A2 formed integral with the housing case A1, so that the rotation member 54d is unable to rotate clockwise beyond the stopper A2. When the user is discarding the magnetic disk apparatus A, the information stored in the magnetic disk 1 can be made unretrievable. Specifically, using the pin 54e, the user turns the rotation member 54d in a predetermined direction (counterclockwise in FIG. 5). Then, as illustrated in broken lines, the hitting member 50 will be released from the rotation member 54d, shot out of the cylinder 52 and hit the slider 31. As a result, the slider 31 will be damaged, thereby rendering retrieval of the stored information impossible.

The arrangements depicted in FIG. 5 may be varied to include an electrical or mechanical device for automatically moving the pin 54e to press and thereby rotate the rotation member 54d upon removal of the magnetic disk apparatus from the installation site.

A magnetic disk apparatus may include a plurality of magnetic disks stacked with a predetermined space provided below and above each disk, and supported by a spindle motor. Each disk has an upper and a lower surfaces serving as recording surface. Correspondingly, a plurality of swing arms and ramps may be provided. In such an instance, a plurality of hitting mechanisms may be provided for the respective ramps. The hitting members may be associated with each other so that they can operate simultaneously.

What is claimed is:

1. A magnetic disk apparatus comprising:
a magnetic disk;
a spindle motor for rotation of the magnetic disk;
a slider formed with a magnetic head for information reading or writing with respect to the magnetic disk, the slider floating above a surface of the magnetic disk in rotation;
a swing arm for supporting and moving the slider above the surface of the magnetic disk;
a ramp disposed adjacent to an outer circumference of the magnetic disk for holding the slider at a withdrawal position spaced away from the surface of the magnetic disk; and
a hitting mechanism for hitting the slider at the withdrawal position.

2. The magnetic disk apparatus according to claim 1, wherein the hitting mechanism includes: a hitting member to be shot toward the slider; an elastic member for urging the hitting member toward the slider; and a stopper mechanism for engagement with the hitting member, the stopper mechanism being disengaged from the hitting member in response to removal of the magnetic disk apparatus from an installation site.

3. The magnetic disk apparatus according to claim 1, wherein the hitting mechanism includes: a hitting member to be shot toward the slider; an elastic member for urging the hitting member toward the slider; and a stopper mechanism for engagement with the hitting member, the stopper mechanism being disengaged from the hitting member in response to selective human operation.

4. The magnetic disk apparatus according to claim 1, further comprising a suspension via which the slider is supported by the swing arm, wherein the suspension is provided with a projection to come into contact with the surface of the magnetic disk after detachment of the slider from the suspension.
